(19) United States
(12) Patent Application Publication
(10) Pub. No.: US 2025/0094770 A1
(43) Pub. Date: Mar. 20, 2025

(54) METHOD AND SYSTEM FOR PERFORMING TIME SERIES IMPUTATION

(71) Applicant: JPMorgan Chase Bank, N.A., New York, NY (US)

(72) Inventors: Elizabeth FONS, London (GB); Yousef EL-LAHAM, Dallas, TX (US); Svitlana VYETRENKO, Colts Neck, NJ (US); Tom Bamford, London (GB)

(73) Assignee: JPMorgan Chase Bank, N.A., New York, NY (US)

(21) Appl. No.: 18/368,341

(22) Filed: Sep. 14, 2023

(51) Int. Cl. G06N 3/045; G06N 3/08

(52) U.S. Cl. CPC G06N 3/045; G06N 3/08

(57) ABSTRACT

A method and a system for performing multivariate time series imputation by using a modulated auto-decoding framework that is built upon implicit neural representations are provided. The method includes: receiving information that relates to a latent vector representation of a time series for which there are missing values; using the received information to generate a set of network weights that is usable by a sinusoidal representation network model for obtaining a functional representation of the time series; modulating a set of sine activation amplitudes of the functional representation of the time series; and using the network weights and the modulated sine activation amplitudes to impute the missing values. The method is performable by using three different neural network models for various functions.

### BACKGROUND

### 1. Field of the Disclosure

This technology generally relates to methods and systems for performing time series imputation, and more particularly to methods and systems for performing multivariate time series imputation by using a modulated auto-decoding framework that is built upon implicit neural representations.

### 2. Background Information

Time series imputation, and related tasks such as forecasting and generation, remain of significant interest in fields as diverse as finance, climate modeling, and healthcare. Traditional approaches, such as averaging and regression, are typically over-simplistic and fail to adequately capture the underlying behavior. The development of more modern methods, including iterative imputation and maximum likelihood routines, have increased the sophistication of the algorithms and improved per-formance, but the underlying assumptions often required by such approaches leads to implicit biases that can be detrimental in more complex cases.

Implicit Neural Representations (INRs) have recently shown to have state-of-the-art performance in a variety of tasks, including shape representation, encoding of object appearance, part-level semantic segmentation and kernel representation. In particular, INR modifications such as periodic activations in sinusoidal representation networks (SIRENs) and positional encodings in neural radiance fields (NeRFs) are able to overcome the spectral bias that traditional neural networks tend to suffer. Additionally, the grid-free learning approach compatible with INRs allow them to work well even for irregularly sampled or missing data.

Implicit Neural Representations (INRs), also referred as neural fields, allow a continuous representation of multidimensional data by encoding a functional relationship between the input coordinates and their corresponding signal value. One of the main advantages of this representation is that the signal is encoded in a grid-free representation, providing an intrinsic non-linear interpolation of the data. One of the first applications of INRs was presented in DeepSDF for shape representation by a continuous volumetric field. DeepSDF is capable of representing an entire class of shapes through the use of an auto-decoder, and showed that a major advantage of the method is that inference can be performed with an arbitrary number of samples. This is particularly relevant to the case of time series imputation, where the time series can be irregularly sampled and the number of samples can vary. More recently, INRs have gained popularity in visual computing due to the key developments of periodic activations and positional encodings, which allow them to learn high-frequency details within the data. Nevertheless, these methods can be computationally expensive or can have limited generalization capability as the complexity of the data increases, even with the use of hypernetworks. There have also been attempts to leverage periodic activations (i.e., SIREN), and their ability to reconstruct high frequency signals, while retaining generalization capabilities, through the addition of a modulation network in the model architecture. The modulator is an additional multi-layer perceptron (MLP) leveraged for generalization, which consists of an identical internal structure to the SIREN (excepting the choice of activation function), such that each node output of the modulator can be matched up to a node in the SIREN, and element-wise multiplication carried out.

While there have been extensive uses of INRs in a wide variety of data sources such as video, images and audio, representation of three-dimensional (3D) scene data, such as 3D geometry and object appearance, few works have leveraged them for time series representation, such as, for example, using INRs for anomaly detection, proposing INRs in combination with meta-learning for time series forecasting, and implementing a hypernetwork+SIREN architecture that is leveraged for time series generation.

Early time series imputation methods, which rely on basic statistical approaches, aim to leverage both the local continuity of the time dimension and the correlations among various channels. For example, the Simple Mean/Simple Median method replaces missing values by taking the mean or median. The k-nearest neighbors (KNN) method uses cross-channel data to fill gaps with the help of k-nearest neighbors. In addition to the straightforward and standard interpolation techniques that utilize polynomial curve fitting, conventional strategies focus on using established forecasting methods and drawing on the similarities between various time series to replace missing data points. For example, some approaches rely on k-nearest neighbors, the expectation-maximization algorithm, or linear predictors and state-space models.

Previous work has shown that deep learning models are able to capture the temporal dependency of time series, giving more accurate imputation than statistical methods. Common approaches use recurrent neural networks (RNNs) for sequence modelling. Subsequent studies combined RNNs with other methods in order to improve imputation performance, such as GANs and self-training. In particular, the combination of RNNs with attention mechanisms have been successful for imputation and interpolation of time series. While most time series imputation methods have focused on deterministic imputation, recently probabilistic methods have been developed, such as Gaussian Process-Variational Auto-Encoders (GP-VAE) and Conditional Score-based Diffusion models for Imputation (CSDI).

Accordingly, there is a need for a mechanism for performing multivariate time series imputation by using a modulated auto-decoding framework that is built upon implicit neural representations.

### SUMMARY

The present disclosure, through one or more of its various aspects, embodiments, and/or specific features or sub-components, provides, inter alia, various systems, servers, devices, methods, media, programs, and platforms for methods and systems for performing multivariate time series imputation by using a modulated auto-decoding framework that is built upon implicit neural representations.

According to an aspect of the present disclosure, a method for performing time series imputation is provided. The method is implemented by at least one processor. The method includes: receiving, by the at least one processor, first information that relates to a latent vector representation of a first time series for which at least one value is missing; generating, by the at least one processor based on the first information, a set of network weights that is usable by a sinusoidal representation network model for obtaining a functional representation of the first time series; modulating, by the at least one processor based on the first information, a set of sine activation amplitudes of the functional representation of the first time series; and imputing, by the at least one processor based on the set of network weights and a result of the modulating, the at least one missing value of the first time series.

The sinusoidal representation network model may include a first neural network model. The generating of the set of network weights may be performed by using a second neural network model. The modulating of the set of sine activation amplitudes may be performed by using a third neural network model.

The method may further include assessing an accuracy of the imputing by obtaining at least one from among a first metric that relates to a mean-squared error between the imputed at least one missing value of the first time series and at least one ground truth value that corresponds to the at least one missing value of the first time series, a second metric that relates to a maximum error between the imputed at least one missing value of the first time series and an evaluation of a model output that corresponds to the at least one missing value of the first time series, and a third metric that relates to a Euclidean distance in a feature space between the imputed at least one missing value of the first time series and the at least one ground truth value that corresponds to the at least one missing value of the first time series.

The method may further include receiving second information that relates to frequency modes of a superset of data that includes the first time series and at least a second time series. The modulating may be further based on the second information.

The method may further include training the sinusoidal representation network model using historical data and optimizing the sinusoidal representation network model with respect to a predetermined loss function.

The first time series may include a univariate time series, such as, for example, a time series that relates to stock market data.

Alternatively, first time series may include a multivariate time series, such as, for example, one from among a time series that relates to yield rate curve data, a time series that relates to weather forecasting data, and/or a time series that relates to medical diagnosis data.

According to another exemplary embodiment, a computing apparatus for performing time series imputation is provided. The computing apparatus includes a processor; a memory; and a communication interface coupled to each of the processor and the memory. The processor is configured to: receive, via the communication interface, first information that relates to a latent vector representation of a first time series for which at least one value is missing; generate, based on the first information, a set of network weights that is usable by a sinusoidal representation network model for obtaining a functional representation of the first time series; modulate, based on the first information, a set of sine activation amplitudes of the functional representation of the first time series; and impute, based on the set of network weights and a result of the modulation, the at least one missing value of the first time series.

The sinusoidal representation network model may include a first neural network model. The processor may be further configured to perform the generation of the set of network weights by using a second neural network model and to perform the modulation of the set of sine activation amplitudes by using a third neural network model.

The processor may be further configured to assess an accuracy of the imputation by obtaining at least one from among a first metric that relates to a mean-squared error between the imputed at least one missing value of the first time series and at least one ground truth value that corresponds to the at least one missing value of the first time series, a second metric that relates to a maximum error between the imputed at least one missing value of the first time series and an evaluation of a model output that corresponds to the at least one missing value of the first time series, and a third metric that relates to a Euclidean distance in a feature space between the imputed at least one missing value of the first time series and the at least one ground truth value that corresponds to the at least one missing value of the first time series.

The processor may be further configured to receive, via the communication interface, second information that relates to frequency modes of a superset of data that includes the first time series and at least a second time series. The modulation may be further based on the second information.

The processor may be further configured to train the sinusoidal representation network model using historical data and to optimize the sinusoidal representation network model with respect to a predetermined loss function.

The first time series may include a univariate time series, such as, for example, a time series that relates to stock market data.

Alternatively, the first time series may include a multivariate time series, such as, for example, a time series that relates to yield rate curve data, a time series that relates to weather forecasting data, and/or a time series that relates to medical diagnosis data.

According to yet another exemplary embodiment, a non-transitory computer readable storage medium storing instructions for performing time series imputation is provided. The storage medium includes executable code which, when executed by a processor, causes the processor to: receive first information that relates to a latent vector representation of a first time series for which at least one value is missing; generate, based on the first information, a set of network weights that is usable by a sinusoidal representation network model for obtaining a functional representation of the first time series; modulate, based on the first information, a set of sine activation amplitudes of the functional representation of the first time series; and impute, based on the set of network weights and a result of the modulation, the at least one missing value of the first time series.

The sinusoidal representation network model may include a first neural network model. The executable code may be further configured to cause the processor to generate the set of network weights by using a second neural network model and to modulate the set of sine activation amplitudes by using a third neural network model.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for performing multivariate time series imputation by using a modulated auto-decoding framework that is built upon implicit neural representations.

FIG. 4 is a flowchart of an exemplary process for implementing a method for performing multivariate time series imputation by using a modulated auto-decoding framework that is built upon implicit neural representations.

FIG. 5 is a diagram that illustrates an architecture of a system that is configured to execute a method for performing multivariate time series imputation by using a modulated auto-decoding framework that is built upon implicit neural representations, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

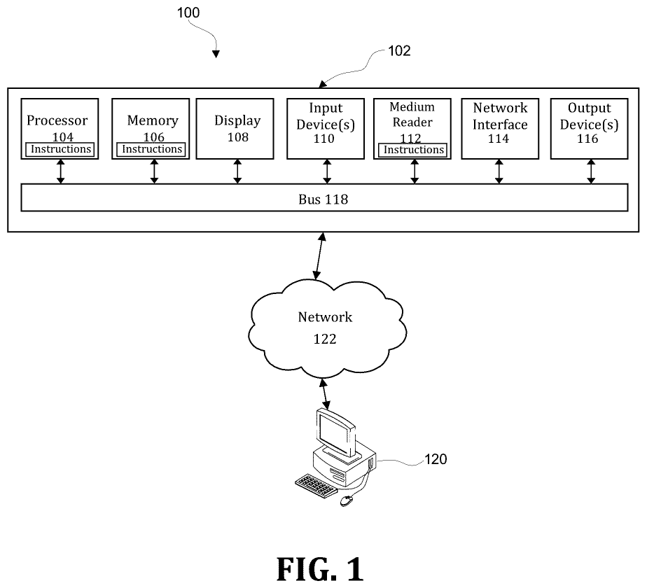

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for performing multivariate time series imputation by using a modulated auto-decoding framework that is built upon implicit neural representations.

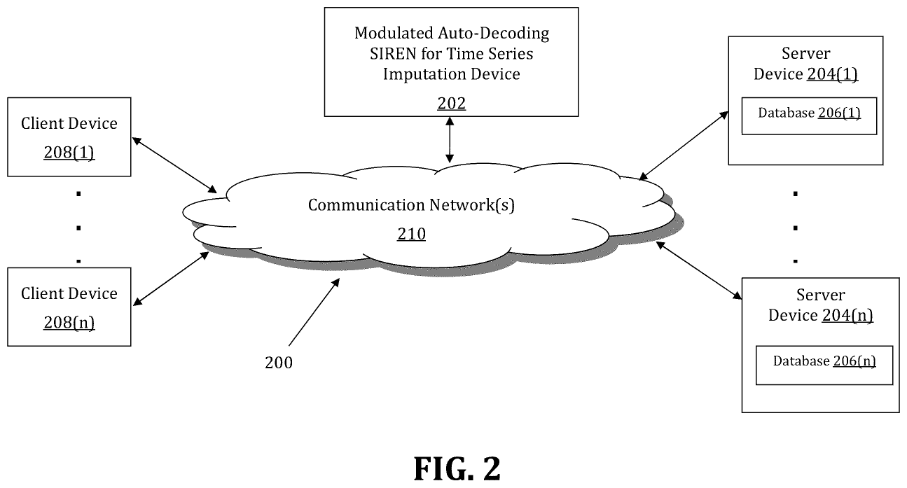

Referring to FIG. 2, a schematic of an exemplary network environment 200 for implementing a method for performing multivariate time series imputation by using a modulated auto-decoding framework that is built upon implicit neural representations is illustrated. In an exemplary embodiment, the method is executable on any networked computer platform, such as, for example, a personal computer (PC).

The method for performing multivariate time series imputation by using a modulated auto-decoding framework that is built upon implicit neural representations may be implemented by a Modulated Auto-Decoding SIREN for Time Series Imputation (MADSTSI) device 202. The MADSTSI device 202 may be the same or similar to the computer system 102 as described with respect to FIG. 1. The MADSTSI device 202 may store one or more applications that can include executable instructions that, when executed by the MADSTSI device 202, cause the MADSTSI device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the MADSTSI device 202 itself, may be located in virtual server(s) running in a cloud-based computing environment rather than being tied to one or more specific physical network computing devices. Also, the application(s) may be running in one or more virtual machines (VMs) executing on the MADSTSI device 202. Additionally, in one or more embodiments of this technology, virtual machine(s) running on the MADSTSI device 202 may be managed or supervised by a hypervisor.

In the network environment 200 of FIG. 2, the MADSTSI device 202 is coupled to a plurality of server devices 204(1)-204(n) that hosts a plurality of databases 206(1)-206(n), and also to a plurality of client devices 208(1)-208(n) via communication network(s) 210. A communication interface of the MADSTSI device 202, such as the network interface 114 of the computer system 102 of FIG. 1, operatively couples and communicates between the MADSTSI device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the MADSTSI device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and MADSTSI devices that efficiently implement a method for performing multivariate time series imputation by using a modulated auto-decoding framework that is built upon implicit neural representations.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The MADSTSI device 202 may be a standalone device or integrated with one or more other devices or apparatuses, such as one or more of the server devices 204(1)-204(n), for example. In one particular example, the MADSTSI device 202 may include or be hosted by one of the server devices 204(1)-204(n), and other arrangements are also possible. Moreover, one or more of the devices of the MADSTSI device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the MADSTSI device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store time series data and data that relates to accuracy metrics for time series imputations.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the MADSTSI device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the MADSTSI device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the MADSTSI device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the MADSTSI device 202, the server devices 204(1)-204(n), or the client devices 208(1)-208(n), for example, may be configured to operate as virtual instances on the same physical machine. In other words, one or more of the MADSTSI device 202, the server devices 204(1)-204(n), or the client devices 208(1)-208(n) may operate on the same physical device rather than as separate devices communicating through communication network(s) 210. Additionally, there may be more or fewer MADSTSI devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the internet, intranets, and combinations thereof.

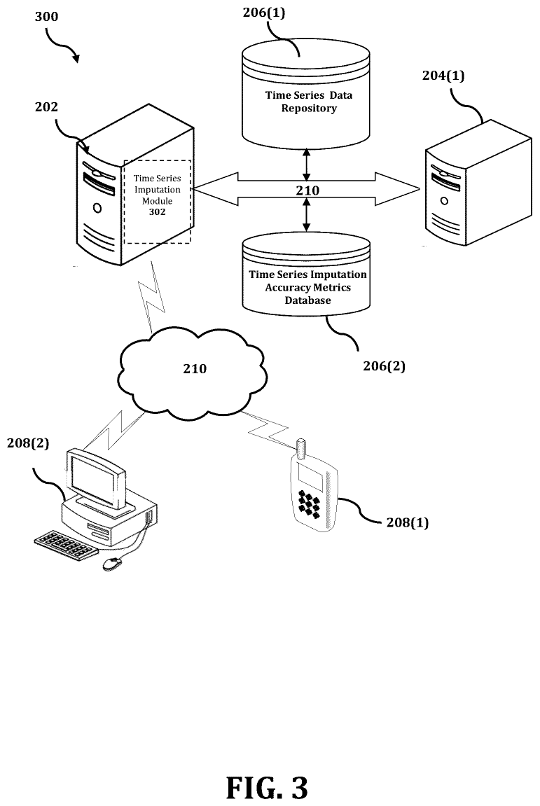

The MADSTSI device 202 is described and illustrated in FIG. 3 as including a time series imputation module 302, although it may include other rules, policies, modules, databases, or applications, for example. As will be described below, the time series imputation module 302 is configured to implement a method for performing multivariate time series imputation by using a modulated auto-decoding framework that is built upon implicit neural representations.

An exemplary process 300 for implementing a mechanism for performing multivariate time series imputation by using a modulated auto-decoding framework that is built upon implicit neural representations by utilizing the network environment of FIG. 2 is illustrated as being executed in FIG. 3. Specifically, a first client device 208(1) and a second client device 208(2) are illustrated as being in communication with MADSTSI device 202. In this regard, the first client device 208(1) and the second client device 208(2) may be “clients” of the MADSTSI device 202 and are described herein as such. Nevertheless, it is to be known and understood that the first client device 208(1) and/or the second client device 208(2) need not necessarily be “clients” of the MADSTSI device 202, or any entity described in association therewith herein. Any additional or alternative relationship may exist between either or both of the first client device 208(1) and the second client device 208(2) and the MADSTSI device 202, or no relationship may exist.

Further, MADSTSI device 202 is illustrated as being able to access a time series data repository 206(1) and a time series imputation accuracy metrics database 206(2). The time series imputation module 302 may be configured to access these databases for implementing a method for performing multivariate time series imputation by using a modulated auto-decoding framework that is built upon implicit neural representations.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the MADSTSI device 202 via broadband or cellular communication. Of course, these embodiments are merely exemplary and are not limiting or exhaustive.

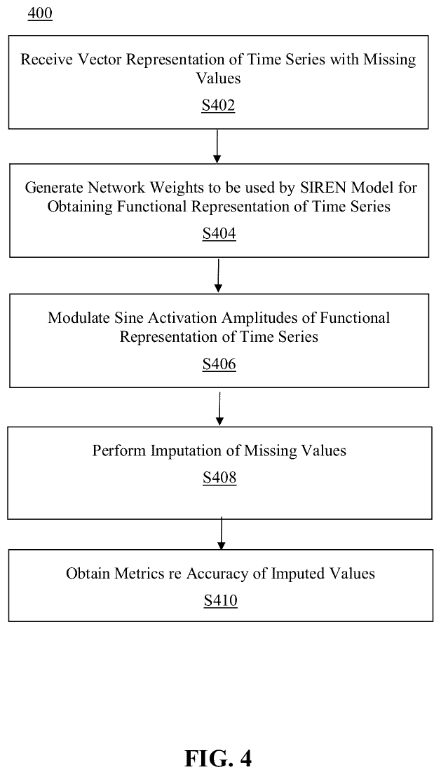

Upon being started, the time series imputation module 302 executes a process for performing multivariate time series imputation by using a modulated auto-decoding framework that is built upon implicit neural representations. An exemplary process for performing multivariate time series imputation by using a modulated auto-decoding framework that is built upon implicit neural representations is generally indicated at flowchart 400 in FIG. 4.

In process 400 of FIG. 4, at step S402, the time series imputation module 302 receives first information that relates to a latent vector representation of a time series for which there is at least one missing value, and generally, there may be many missing values. In an exemplary embodiment, the time series may be a univariate time series, such as, for example, a time series that relates to stock market data, i.e., stock prices. Alternatively, the time series may be a multivariate time series, such as, for example, yield rate curve data, weather forecasting data, and/or medical diagnosis data.

At step S404, the time series imputation module 302 uses the first information received in step S402 to generate a set of network weights that is usable by a sinusoidal representation network (SIREN) model for obtaining a functional representation of the time series. In an exemplary embodiment, the SIREN model is a first type of neural network model, and the generation of the set of network weights is performed by a second type of neural network model. In an exemplary embodiment, the SIREN model is trained by using historical data that relates to the time series. Further, the SIREN model may be optimized with respect to a predetermined loss function.

At step S406, the time series imputation module 302 uses the latent vector representation of the time series to modulate a set of sine activation amplitudes of the functional representation of the time series generated by the SIREN model. In an exemplary embodiment, the modulation is performed by a third type of neural network model.

In an exemplary embodiment, the time series imputation model 302 receives second information that relates to frequency modes of a superset of data that relates to the time series, such as, for example, several separate individual time series that all relate to the same genre of data, but occur over different time periods. In this scenario, the modulation of step S406 may be performed based on the second information.

At step S408, the time series imputation module 302 performs an imputation of the missing values of the time series. The imputation is based on the network weights and a result of the modulation. The result of the imputation is a determination of estimated values that correspond to the missing values of the time series.

At step S410, the time series imputation module 302 assesses an accuracy of the imputation by obtaining one or more metrics that serve as measurements for the accuracy. In an exemplary embodiment, the metrics may include any one or more of a first metric that relates to a mean-squared error between the imputed missing values and ground truth values that correspond to the missing values, a second metric that relates to a maximum error between the imputed missing values and an evaluation of a model output that corresponds to the missing values, and a third metric that relates to a Euclidean distance in a feature space between the imputed missing values and the ground truth values that correspond to the missing values.

In an exemplary embodiment, a novel method for multivariate time series imputation via a Modulated Auto-Decoding SIREN (MADS) system is disclosed. MADS utilizes the capabilities of SIRENs for high fidelity reconstruction of signals and irregular data handling. In the MADS system, the SIREN parameterizations are combined with hypernetworks in order to learn a prior over the space of time series.

In an exemplary embodiment, an objective is to solve the problem of in-filling missing data via the proposed MADS model. A general multivariate time series is represented by a matrix of values X=(x₀, . . . , x_{N})^{T}∈ [symbol] ^{N,D} sampled at timesteps T=(t₀, . . . , t_{N}), where D is the dimensionality of the series. Each column of this matrix therefore represents an individual time series corresponding to a feature of the original. Note that in general, the timesteps are not regularly spaced. A corresponding mask matrix may then be defined as M∈{0×1}^{N,D}, in which an element Mᵢⱼ=0 if the corresponding element in X is missing. In general there may be no pattern to these missing values, and all feature values at a given timestep could be missing.

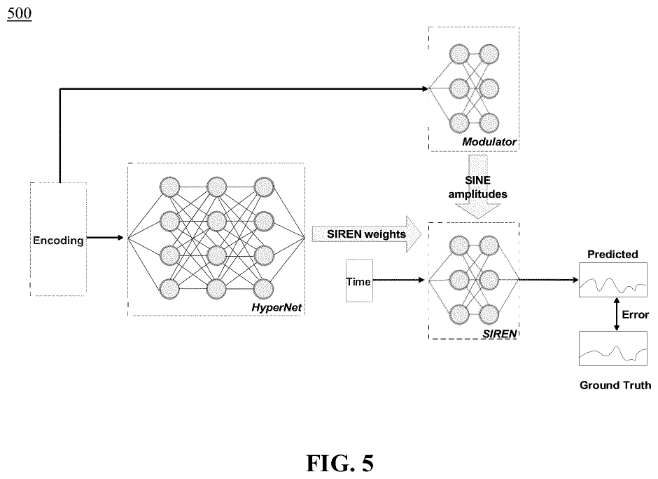

FIG. 5 is a diagram 500 that illustrates an architecture of a system that is configured to execute a method for performing multivariate time series imputation by using a modulated auto-decoding framework that is built upon implicit neural representations, according to an exemplary embodiment. The architecture consists of three networks: the foundational SIREN, a hypernet, and a modulator. The hypernet takes in a latent code corresponding to a given time series, and outputs a set of network weights. These weights map to those inside the SIREN, and thus a distinct Implicit Neural Representation (INR) is instantiated for each individual time series from which imputation is carried out. Rather than utilizing an encoding network to calculate the latent vectors, MADS follows the auto-decoding setup of DeepSDF, which was found to be similarly capable without the additional network overhead. In this setup, the latent values are treated as variables during training (and so backpropagated), and then optimized again during inference for a given time series, when all other network variables are fixed.

The third network is used for amplitude modulation. In an exemplary embodiment, such a network has been shown to improve generalization performance significantly, relative to traditional auto-decoding or hypernetwork-based SIREN models. For a given sample, the modulator varies sine activation amplitudes within SIREN, allowing certain frequency modes to be nullified. While the original model was applied to image-based data, and tasks such as up-sampling and image relighting, the applicability to time series and imputation in particular is clear.

In an exemplary embodiment, a modulation network is leveraged alongside the hypernet. For a given time series this allows both SIREN weights and activation amplitudes to be varied, with the modulation network applying the weights through an element-wise mapping to the SIREN. Defining W and b as SIREN network weights and biases respectively, the output of the i'th hidden SIREN layer

$${h}_{i} = sin ( {W}_{i} {h}_{i - 1} + {b}_{i} ) , \qquad ( Expression 1 )$$

$$becomes$$

$${h}_{i} = {α}_{i} ⊙ sin ( {W}_{i} {h}_{i - 1} + {b}_{i} ) \qquad ( Expression 2 )$$

such that the Hadamard product is applied between modulator hidden layer outputs di and the periodic activation function of SIREN. The modulation network is therefore constrained to having the same structure as the SIREN.

In an exemplary embodiment, two formulations of MADS are considered. In the first formulation, referred to herein as “base,” the modulator takes in the same latent representation as that input into the hypernet, so that the modulated amplitudes vary with each individual time series. Since the modulator is introduced to limit overfitting, this can lead to amplitude variations for each time series that are too unconstrained. For this reason, the second formulation is a more robust formulation that learns the frequency modes of the entire dataset rather than individual time series. In this setup, a distinct latent space is input into the modulator. As before, the latent variable values are learned during training, but in this case no optimization is carried out before inference, such that the latent values are shared across the full dataset. This is referred to herein as the “fixed” formulation.

To summarize, in an exemplary embodiment, MADS constitutes the following features: 1) SIREN—functional representation of a given time series, taking an input timepoint and outputting corresponding amplitudes; 2) Hypernet—takes in a latent vector representation of a time series and outputs a set of network weights used to instantiate the SIREN; 3) Modulator—takes in a latent vector representation of a time series/dataset and modulates the sine activation amplitudes of SIREN through element-wise multiplication; and 4) Auto-decoding structure—treat latent variables as trainable parameters, and re-optimize during inference of a particular time series.

In an exemplary embodiment, the model may be evaluated by using real world, multivariate datasets. One such dataset is the Human Activity dataset (HAR), which consists of three-dimensional spatial data collected from 5 people while carrying out a range of activities (sitting, walking, standing etc.). Four sensors were attached to each person-on their chest, belt and both ankles-giving 12 features in total. A predefined pre-processing scheme is also performed, thereby yielding 6554 time series. In an exemplary embodiment, a specified fraction of known values are selected randomly for removal, acting as ground truths for imputation. The missing data are selected randomly from each time series and the missing data fraction is user-specified; two regimes of data may be evaluated with low/high missing data fractions, set here to 0.3 and 0.7 respectively. In an exemplary embodiment, the same randomly chosen missing timesteps for imputation are used across all features and time series. In addition, the dataset is split randomly into a train/test pair, with 20% of the time series being designated to the test set. Each time series consists of 50 timesteps after pre-processing.

A second real world dataset that may be used is the Air Quality dataset, which consists of PM2.5 measurements taken from 36 measuring stations in Beijing, over a period of 12 months. The measurements were collected every hour. A predefined set of pre-processing steps of the data into a train-test split is performed. In total, the dataset contains 158/80 samples for training/testing, with 36 features and the same number of timesteps.

In an exemplary embodiment, a baseline sinusoidal toy time series (univariate) is constructed through the following expression:

$${y}_{n} = {e}^{- γ ( {t}_{} n + 1 )} sin ( Ω {t}_{n} + ϕ ) + ϵ , \qquad ( Expression 3 )$$

where ϕ˜N(0, 1), Ω˜ω×Beta(2, 2), ϵ˜0.2×N(0, 1), and tₙ∈{−1, . . . , 1}.

The exponential factor driven by the decay factor γ is included to model non-stationarity in the time series, while the beta distribution is scaled up by a constant multiplicative factor, ω, to modify the frequency of modes within the dataset.

To construct multivariate time series, the univariate equation is sampled multiple times to create a vector of independent time series, which can then be assigned as individual features. In this case, the amplitude is also taken from a Beta distribution, with all feature amplitudes re-scaled such that the maximum amplitude is 1. Typically, 200 timesteps are used to sample the time series, which is high enough to prevent aliasing in frequencies up to at least ω=100.

Note that the ground truth imputation values and train-test split follows that of the Human Activity dataset, i.e. missing values are randomly chosen and 20% of the dataset is assigned to the test set. The total size of the dataset is set to 3000.

Metrics: In an exemplary embodiment, to assess model performance, three metrics may be used, each of which assesses out-of-sample imputation accuracy. To evaluate, the model prior is set to the non-missing data of the test set, then evaluation is carried out on the missing points from the same dataset. The metrics used can be summarized as follows: 1) Imputation error: Mean-squared error (MSE) between the predicted (imputed) points in the test set compared to ground truth. 2) Maximum imputation error (Max): measures the maximum error between missing data from the test set and those points evaluated using the trained model, then computes the average across all time series. 3) Wasserstein2 (W2): Euclidean distance in feature space between learned distributions, pairing missing points in the ground truth and output set so as to minimize the total summed distance between pairs.

Implementation: In an exemplary embodiment, during training, the model is optimized with respect to the following loss function,

$$∠ = {∠}_{mse} + {∠}_{latent} + {∠}_{weights} , \qquad ( Expression 4 )$$

In Expression 4, the first term is the standard MSE loss, defined via

$${ℒ}_{mse} = \frac{1}{N} {\sum }_{i = 1}^{N} {( {f}_{i} - {\hat{f}}_{i} )}^{2} ,$$

while the second and third terms are regularization terms on the (hypernet) latent code and SIREN network weights respectively,

$${ℒ}_{latent} = {λ}_{Z} \frac{1}{{N}_{Z}} {\sum }_{j = 1}^{{N}_{z}} {z}_{i}^{2} \qquad ( Expression 5 )$$

$${ℒ}_{weights} = {λ}_{w} \frac{1}{{N}_{w}} {\sum }_{k = 1}^{{N}_{w}} {W}_{K}^{2} . \qquad ( Expression 6 ) .$$

In an exemplary embodiment, the number of latent dimensions, Nz, is set to 40. In addition, gradient clipping is used during training, which has been found to improve performance. λz and λw are set to 0.1 and 0.0001 respectively. The latent space prior is set to the normal distribution

$$z ∼ \dot{𝒩} ( 0 , \frac{1}{{N}_{w}} ) ,$$

and it has been found that initializing the latent codes from a more compact distribution, z˜ [symbol] (0,0.01), during inference led to better generalization performance. In an exemplary embodiment, optimization is carried out using the Adam optimizer, with a learning rate of 5e-05 for model parameters, and 1e-03 for latent variables. Note that in the fixed formulation, only latent variables passing through the hypernet are regularized. The SIREN network consists of three fully-connected layers with hidden dimension of 60, while the hypernet is composed of a single hidden layers and a hidden feature size of 128. The modulator is constrained to the same structure as SIREN, with the activations replaced by rectified linear unit (ReLU) functions.

Accordingly, with this technology, a process for performing multivariate time series imputation by using a modulated auto-decoding framework that is built upon implicit neural representations is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for performing time series imputation, the method being implemented by at least one processor, the method comprising:
receiving, by the at least one processor, first information that relates to a latent vector representation of a first time series for which at least one value is missing;
generating, by the at least one processor based on the first information, a set of network weights that is usable by a sinusoidal representation network model for obtaining a functional representation of the first time series;
modulating, by the at least one processor based on the first information, a set of sine activation amplitudes of the functional representation of the first time series; and
imputing, by the at least one processor based on the set of network weights and a result of the modulating, the at least one missing value of the first time series.

2. The method of claim 1, wherein the sinusoidal representation network model comprises a first neural network model, and the generating of the set of network weights is performed by using a second neural network model, and the modulating of the set of sine activation amplitudes is performed by using a third neural network model.

3. The method of claim 1, further comprising assessing an accuracy of the imputing by obtaining at least one from among a first metric that relates to a mean-squared error between the imputed at least one missing value of the first time series and at least one ground truth value that corresponds to the at least one missing value of the first time series, a second metric that relates to a maximum error between the imputed at least one missing value of the first time series and an evaluation of a model output that corresponds to the at least one missing value of the first time series, and a third metric that relates to a Euclidean distance in a feature space between the imputed at least one missing value of the first time series and the at least one ground truth value that corresponds to the at least one missing value of the first time series.

4. The method of claim 1, further comprising receiving second information that relates to frequency modes of a superset of data that includes the first time series and at least a second time series,
wherein the modulating is further based on the second information.

5. The method of claim 1, further comprising training the sinusoidal representation network model using historical data and optimizing the sinusoidal representation network model with respect to a predetermined loss function.

6. The method of claim 1, wherein the first time series comprises a univariate time series.

7. The method of claim 6, wherein the univariate time series comprises a time series that relates to stock market data.

8. The method of claim 1, wherein the first time series comprises a multivariate time series.

9. The method of claim 8, wherein the multivariate time series comprises one from among a time series that relates to yield rate curve data, a time series that relates to weather forecasting data, and a time series that relates to medical diagnosis data.

10. A computing apparatus for performing time series imputation, the computing apparatus comprising:
a processor;
a memory; and
a communication interface coupled to each of the processor and the memory,
wherein the processor is configured to:
receive, via the communication interface, first information that relates to a latent vector representation of a first time series for which at least one value is missing;
generate, based on the first information, a set of network weights that is usable by a sinusoidal representation network model for obtaining a functional representation of the first time series;
modulate, based on the first information, a set of sine activation amplitudes of the functional representation of the first time series; and
impute, based on the set of network weights and a result of the modulation, the at least one missing value of the first time series.

11. The computing apparatus of claim 10, wherein the sinusoidal representation network model comprises a first neural network model, and wherein the processor is further configured to perform the generation of the set of network weights by using a second neural network model and to perform the modulation of the set of sine activation amplitudes by using a third neural network model.

12. The computing apparatus of claim 10, wherein the processor is further configured to assess an accuracy of the imputation by obtaining at least one from among a first metric that relates to a mean-squared error between the imputed at least one missing value of the first time series and at least one ground truth value that corresponds to the at least one missing value of the first time series, a second metric that relates to a maximum error between the imputed at least one missing value of the first time series and an evaluation of a model output that corresponds to the at least one missing value of the first time series, and a third metric that relates to a Euclidean distance in a feature space between the imputed at least one missing value of the first time series and the at least one ground truth value that corresponds to the at least one missing value of the first time series.

13. The computing apparatus of claim 10, wherein the processor is further configured to receive, via the communication interface, second information that relates to frequency modes of a superset of data that includes the first time series and at least a second time series, and
wherein the modulation is further based on the second information.

14. The computing apparatus of claim 10, wherein the processor is further configured to train the sinusoidal representation network model using historical data and to optimize the sinusoidal representation network model with respect to a predetermined loss function.

15. The computing apparatus of claim 10, wherein the first time series comprises a univariate time series.

16. The computing apparatus of claim 15, wherein the univariate time series comprises a time series that relates to stock market data.

17. The computing apparatus of claim 10, wherein the first time series comprises a multivariate time series.

18. The computing apparatus of claim 17, wherein the multivariate time series comprises one from among a time series that relates to yield rate curve data, a time series that relates to weather forecasting data, and a time series that relates to medical diagnosis data.

19. A non-transitory computer readable storage medium storing instructions for performing time series imputation, the storage medium comprising executable code which, when executed by a processor, causes the processor to:
receive first information that relates to a latent vector representation of a first time series for which at least one value is missing;
generate, based on the first information, a set of network weights that is usable by a sinusoidal representation network model for obtaining a functional representation of the first time series;
modulate, based on the first information, a set of sine activation amplitudes of the functional representation of the first time series; and
impute, based on the set of network weights and a result of the modulation, the at least one missing value of the first time series.

20. The storage medium of claim 19, wherein the sinusoidal representation network model comprises a first neural network model, and wherein the executable code is further configured to cause the processor to generate the set of network weights by using a second neural network model and to modulate the set of sine activation amplitudes by using a third neural network model.
